(19) United States
(12) Patent Application Publication
(10) Pub. No.: US 2020/0176767 A1
(43) Pub. Date: Jun. 4, 2020

(54) CHALCOGENIDE POLYMER-CARBON COMPOSITES AS ACTIVE MATERIALS FOR BATTERIES

(71) Applicant: REPSOL, S.A., MADRID (ES)

(72) Inventors: Luisa María FRAGA TRILLO, MÓSTOLES (ES); Juan NICOLÁS AGUADO, MÓSTOLES (ES); Rodrigo PARIS ESCRIBANO, MÓSTOLES (ES); José Alberto BLAZQUEZ MARTÍN, SAN SEBASTIÁN (ES); Olatz LEONET BOUBETA, DONOSTIA-SAN SEBASTIÁN (ES); Eneko AZACETA MUÑOZ, DONOSTIA-SAN SEBASTIÁN (ES); Idoia URDAMPILLETA GONZALEZ, DONOSTIA-SAN SEBASTIÁN (ES); Oscar MIGUEL, DONOSTIA-SAN SEBASTIÁN (ES)

(21) Appl. No.: 16/608,163

(22) PCT Filed: May 2, 2018
(86) PCT No.: PCT/EP2018/061210

§ 371 Date: Oct. 24, 2019

(30) Foreign Application Priority Data
May 3, 2017 (EP) 17382241.2

(51) Int. Cl. H01M 4/38; H01M 4/62; H01M 4/136; H01M 4/04; C08J 3/24

(52) U.S. Cl. CPC H01M 4/38; H01M 4/622; H01M 2004/028; H01M 4/049; C08J 3/24; H01M 4/136

(57) ABSTRACT

It is provided a chalcogenide polymer-carbon composite comprising from 70.0 to 99.0 mol % of a chalcogenide; from 0.5 to 20.0 mol % of carbon in the form of a carbonaceous material, and from 0.5 to 10.0 mol % of a crosslinking moiety, with respect to the total amount of chalcogenide, carbon, and crosslinking moiety, wherein the chalcogenide is in the form of chalcogenide chains bonded to the crosslinking moiety and they are forming a structure wherein the carbonaceous material is embedded. It is also provided a process for its preparation, as well as a cathode comprising the chalcogenide polymer-carbon composite, and a battery comprising the cathode.

This application claims the benefit of European Patent Application EP17382241.2 filed May 3, 2017.

### TECHNICAL FIELD

The present invention relates to the field of rechargeable batteries. In particular, it is related to electrode materials comprising a chalcogenide and a carbonaceous material as well to a process for its preparation.

### BACKGROUND ART

Lithium sulfur battery technology is one of the promising candidates for next generation energy storage systems with low cost and high energy density. The natural abundance, therefore its low cost, the environmentally friendliness, and the theoretical high electrochemical properties of sulfur have boosted the research in this area the last decade. However these batteries suffer from different drawbacks. For one hand the insulating nature of sulfur (10⁻³⁰Ω) needs high amount of conductive additive that translates into a lowering of the final capacity of the battery. For the other hand, the solubility of the discharge intermediates into the electrolyte leads to the so-called polysulfide shuttle. That is, the migration of these intermediates to the lithium metal anode though the electrolyte, and the reaction with lithium to form an insoluble layer of lithium sulfide causes both the passivation of the anode and the corrosion of the cathode.

A lot of effort has been devoted to reduce the shuttle effect and improve the retention of sulfur active material within the sulfur electrode. Some approaches are focused on developing sulfur electrodes with favorable nanostructures and properties to improve the discharge capacity, cycle life, and Coulombic efficiency. Among all the strategies reported in the state of the art, porous/conductive carbon has received considerable attention due to its porous structure and high electrical conductivity, which are essential criteria for simultaneously accommodating the active material and enhancing the cathode conductivity. The cathode conductivity is increased by two morphological routes: (i) formation of a conductive carbon network, e.g., carbon nanoparticles clusters—carbon conductive additive; (ii) intimate connection between the conductive framework and the insulating sulfur by means of the synthesis of sulfur/porous carbon—carbon hosting-composites. So far, various carbon “hosting” materials and synthetic routes that are dedicated to optimize the composite configuration have provided significant improvements in the cycling performances of Li—S cells.

The first sulfur/porous carbon composites were presented by Wang et al. (“Sulfur-carbon nano-composite as cathode for rechargeable lithium battery based on gel electrolyte”, Electrochem. Commun. 2002, Vol. 4, pp. 499-502). The applied porous carbon serves as electrical conductor for increasing the sulfur cathode conductivity and also as a storage container for the sulfur active material in its porous structure. This concept makes sulfur cathodes exhibit better cycle life compared to a simple mixture between pure sulfur and a carbon conductive additive. Following this concept, numerous and various porous carbon materials have been developed, as well as different synthetic pathways to confine the sulfur within the structure of such carbon “hosting” materials.

As an alternative to the sulfur/porous carbon composites, Griebel et al. have combined, by a simple and physical mixture, a carbon conductive additive with sulfur copolymers (“Kilogram Scale Inverse Vulcanization of Elemental Sulfur to Prepare High Capacity Polymer Electrodes for Li—S Batteries”; J. Polymer Sci., Part A: Polym. Chem., 2015, Vol. 53, pp. 173-177). The sulfur copolymer/carbon conductive mixture is obtained by ball-milling copolymer powder with carbon and polyethylene as a binder in a mass ratio of 75:20:5. The batteries prepared by this process have a relative low sulfur loading (0.75 mg_{Sulfur} cm⁻²), showing an improved cycling performance in comparison to those based on elemental sulfur/porous carbon composites.

Similarly, WO2017011533 discloses a method of producing a sulfur copolymer, said method comprising heating sulfur until it is melt, adding one or more comonomers such as a styrenic monomer to the liquid sulfur, and optionally a nucleophilic activator, and carrying out a polymerization reaction in order to obtain a sulfur copolymer. It is also disclosed that sulfur copolymers electrodes may further comprise a carbon conductive additive dispersed therein. Despite of the improvement in the capacity retention under the cycling, this strategy performs a lower specific capacity per gram of sulfur than conventional sulfur electrodes based on sulfur/porous carbon composites, even at low current densities, due to the low electrical conductivity of the sulfur copolymers.

Selenium is another promising candidate as active material vs lithium metal. This element from the same group than sulfur and oxygen possesses interesting electrochemical properties. It has a lower specific capacity than sulfur (675 mAh/gₛₑₗₑₙᵢᵤₘ vs 1672 mAh/g_{sulfur}) but due to its high density, the volumetric capacity of both elements is very similar. In addition, selenium is considered a semiconductor due to its very high conductivity (10⁻³Ω).

It has been investigated that the reduction mechanism of the selenium vs lithium in ether based electrolyte is very similar to the one of sulfur and that the discharge products (Li₂Se and Li₂Se₂) are electroactive, what leads to a high stability during cycling. However selenium suffers from different practical drawbacks. As it is not as abundant as sulfur, selenium is much more expensive. In the battery, the working voltage of selenium is lower than sulfur, what decreases the energy that a battery can provide.

In an attempt to combine the advantages of both sulfur and selenium, some research has been done in lithium sulfur-selenium batteries. Taking into account the ratio between these two active materials, the synthesis of different sulfur-selenium compounds has been reported in the literature (cf. A. Abouimrane et al., “A New Class of Lithium and Sodium Rechargeable Batteries Based on Selenium and Selenium—Sulfur as a Positive Electrode”, Journal of the American Chemical Society, 2012, Vol. 134, pp. 4505-4508;). Similarly, US20120225352 discloses selenium-containing compounds and selenium-carbon composites as cathode electrodes in rechargeable batteries. Although these compounds exhibited excellent electrochemical properties in terms of capacity, capacity retention, and cycle life at high C rates, there is still an interest in improving the performace of batteries.

In view of what is described above, new lithium-chalcogenide/carbon batteries featuring improved capacity, reversibility, and costs would represent a huge step forward in the development of next-generation energy storage devices.

### SUMMARY OF INVENTION

The inventors have found that when inverse vulcanization of a chalcogenide, particularly of sulfur or of sulfur and selenium, is carried out in the presence of a certain amount of carbon, a cathodic material with improved electrochemical properties is obtained. Thus, the batteries based on this cathodic material show a good performance in terms of capacity, capacity retention and cycle life, not only at high C rates but also at low C rates. Additionally, the method makes possible a high sulfur loading (>1 mg·cm⁻²) and, at the same time, a high sulfur ratio (>60%).

Thus, a first aspect of the invention relates to a chalcogenide polymer-carbon composite comprising:
from 70.0 to 99.0 mol % of a chalcogenide;
from 0.5 to 20.0 mol % of carbon in the form of a carbonaceous material, and
from 0.5 to 10.0 mol % of a crosslinking moiety, with respect to the total amount of chalcogenide, carbon, and crosslinking moiety, wherein the chalcogenide is in the form of chalcogenide chains bonded to the crosslinking moiety and they are forming a structure wherein the carbonaceous material is embedded.

According to the teaching of the prior art, although the mixture of a carbon conductive additive with sulfur copolymers (“Griebel et al. ibid.) shows a better performance in terms of capacity retention with the cycle life in comparison to those based on elemental sulfur/porous carbon composites, for the time being, no improvement on the specific capacity at low current intensities has been reported.

Surprisingly, as can be seen from the examples, electrodes based on the sulfur polymer-carbon composites as defined above show a behavior similar to a reference electrode based on elemental sulfur in terms of specific capacity, not only at low current intensities but also at high current intensities. Unexpectedly, in spite of a higher sulfur content in the sulfur polymer-carbon composites of the invention and a reduced amount of the conductive additive in the final electrode formulation, an improvement on the capacity per gram of electrode at low current intensities is observed. This makes it possible to increase the sulfur content in the electrode and, as a result, the energy density, that is, capacity per electrode weight unit. The same effect is observed with other chalcogenides, including mixtures of S, Se, and/or Te, particularly of S and Se.

A second aspect of the invention relates to a process for the preparation of a chalcogenide polymer-carbon composite as defined in any of the claims 1-8 by inverse vulcanization, the process comprising:
a) melting from 70.0 to 99.0 mol % of chalcogenide and adding to the melted chalcogenide from 0.5 to 20.0 mol % of carbon under stirring, or
   alternatively, melting a mixture of the mentioned amounts of chalcogenide and carbon,
   in order to form a homogeneous suspension;
b) adding to the suspension of step a) from 0.5 to 10.0 mol % of a crosslinking monomer having at least one unsaturated double or triple bond to obtain a reaction mixture; and
c) allowing the reaction mixture of step b) to react in order to obtain the chalcogenide polymer-carbon composite.

A third aspect of the invention relates to a cathode comprising the chalcogenide polymer-carbon composite as defined above.

A fourth aspect of the invention relates to a chalcogenide/carbon battery comprising a) an anode comprising an element selected from the group consisting of lithium, magnesium, sodium, and calcium; b) a cathode comprising the chalcogenide polymer-carbon composite as defined above; and c) a suitable electrolyte interposed between the cathode and the anode.

### BRIEF DESCRIPTION OF DRAWINGS

FIG. 1 shows the specific capacity per gram of sulfur during the cycling of the battery at different current intensities and different cycle number for electrodes based on a sulfur-carbon composite ([1] sulfur/KB (20.0%) [56% sulfur in the electrode]), a sulfur polymer having a high conducting additive content ([2] sulfur polymer (10% DVB) [56% sulfur in the electrode]), and a sulfur polymer having a low conducting additive content ([3] sulfur polymer (10% DVB) [65% sulfur in the electrode]) for electrodes with a sulfur loading of 2.0 mg cm⁻². KB: Ketjen Black 600JD; DVB: divinylbenzene.

FIG. 2 shows the specific capacity per gram of sulfur during the cycling of the battery at different current intensities for electrodes based on sulfur-carbon composite [1] and two different sulfur polymer-carbon composites (carbon type KB; [4] sulfur polymer (10% DVB)/KB (1.0%) [64% sulfur in the electrode], and [5] sulfur polymer (10% DVB)/KB (2.0%) [64% sulfur in the electrode]), for electrodes with a sulfur loading of 2.0 mg cm⁻².

FIG. 3 shows the specific capacity per gram of sulfur during the cycling of the battery at different current intensities and different cycle number for electrodes based on sulfur-carbon composite [1] and two different sulfur polymer-carbon composites (carbon type C45; [6] sulfur polymer (10% DVB)/C45 (2.0%) [64% sulfur in the electrode], and [7] sulfur polymer (10% DVB)/C45 (3.5%) [63% sulfur in the electrode]), for electrodes with a sulphur loading of 2.0 mg cm⁻². C45: Carbon Black C45.

FIG. 4 shows the specific capacity per gram of sulfur during the cycling of the battery at different current intensities and different cycle number for electrodes based on sulfur-carbon composite [1] and three different sulfur polymer-carbon composites (carbon type CNT; [8] sulfur polymer (10% DVB)/CNT (2.0%) [64% sulfur in the electrode], [9] sulfur polymer (10% DVB)/CNT (3.5%) [63% sulfur in the electrode], and [10] sulfur poly.(10% DVB)/CNT (5.0%) [62% sulfur in the electrode]), for electrodes with a sulfur loading of 2.0 mg cm⁻². CNT: Graphistrength C100 carbon nanotube.

FIG. 5 shows the specific capacity per gram of sulfur during the cycling of the battery at a current intensity equivalent to 5 hours of charge/discharge for electrodes based on sulfur-carbon composite [1], a sulfur polymer having a high conducting additive content ([2], 56 wt % S), and a sulfur polymer having a low conducting additive content ([3], 65 wt % S), for electrodes with a sulfur loading of 2.0 mg cm⁻².

FIG. 6 shows the specific capacity per gram of sulfur during the cycling of the battery at a current intensity equivalent to 5 hours of charge/discharge for electrodes based on sulfur-carbon composite [1] and two different sulfur polymer-carbon composites (carbon type KB), [4] and [5], for electrodes with a sulfur loading of 2.0 mg cm⁻².

FIG. 7 shows the specific capacity per gram of sulfur during the cycling of the battery at a current intensity equivalent to 5 hours of charge/discharge for electrodes based on a sulfur-carbon composite [1] and two different sulfur polymer-carbon composites (carbon type C45), [6] and [7], for electrodes with a sulphur loading of 2.0 mg cm⁻².

FIG. 8 shows the specific capacity per gram of sulfur during the cycling of the battery at a current intensity equivalent to 5 hours of charge/discharge for electrodes based on a sulfur-carbon composite [1] and three different sulfur polymer-carbon composites (carbon type CNT), [8], [9], and [10], for electrodes with a sulfur loading of 2.0 mg cm⁻².

FIG. 9 shows the specific capacity per gram of sulfur during the cycling of the battery at a current intensity equivalent to 5 hours of charge/discharge for electrodes based on a sulfur polymer having a low conducting additive content ([3], 65 wt % S), a sulfur polymer-carbon composite ([4], carbon type KB), and a sulfur-selenium polymer-carbon composite ([4Bis], sulfur-selenium polymer/KB (1.0%) [57.5% S+7.5% Se in the electrode]), for electrodes with a sulfur loading of 2.0 mg cm⁻².

FIG. 10 shows the specific capacity per gram of sulfur during the cycling of the battery at a current intensity equivalent to 5 hours of charge/discharge for electrodes based on sulfur polymer-carbon composite [4] obtained by using DVB as a crosslinker, and sulfur polymer-carbon composites obtained with the same amount of S, carbon (KB) and crosslinker but, using a different crosslinker (particularly DIB, DAS, or Myr), for electrodes with a sulfur loading of 2.0 mg cm⁻². DIB: 1,3-diisopropenyl benzene; DVB: divinylbenzene; DAS: diallyl disulfide; Myr: myrcene.

### DETAILED DESCRIPTION OF THE INVENTION

For the sake of understanding, the following definitions are included and expected to be applied throughout description, claims and drawings.

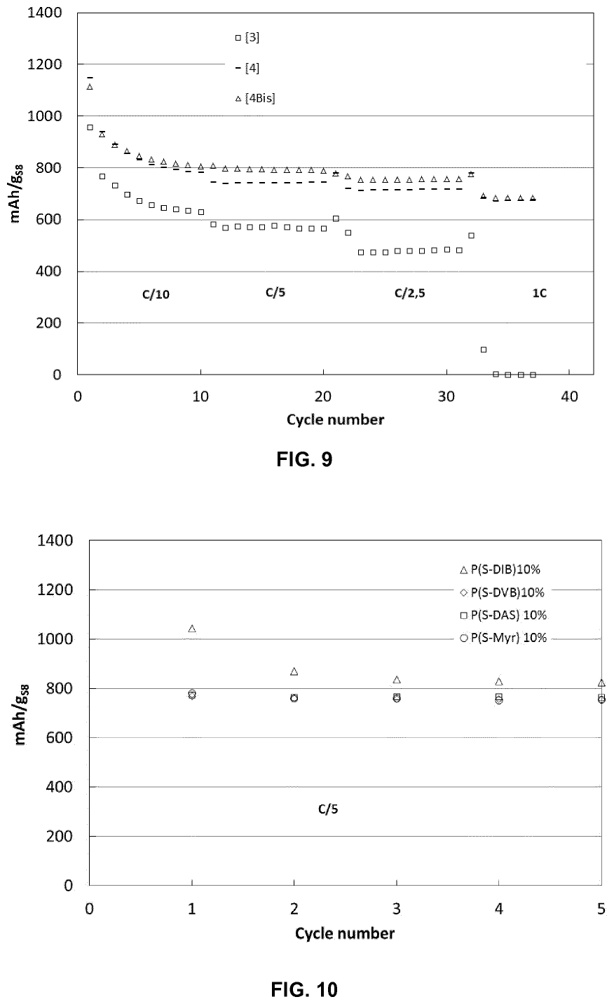

As used herein, “chalcogenide” refers to a compound containing one or more chalcogen elements. One of ordinary skill in the art will understand that the classical chalcogen elements are sulfur, selenium, and tellurium. Particularly, the chalcogenide is sulfur. More particularly, the chalcogenide is a mixture of sulfur and selenium. As shown in FIG. 9, similar results are obtained when a sulfur polymer-carbon composite [4] or a sulfur-selenium polymer [4Bis] is used. Also similar results are expected to be obtained with a mixture of sulfur and tellurium.

As used herein, sulfur can be provided as elemental sulfur, for example, in powdered form. Under ambient conditions, elemental sulfur primarily exists in an eight-membered ring form (S₈) which melts at temperatures in the range of 120° C.-130° C. and undergoes an equilibrium ring-opening polymerization (ROP) of the S₈ monomer into a linear polysulfide with diradical chain ends. Sulfur can also be in the form of other allotropes. Any sulfur species that yield diradical or anionic polymerizing species when melted can be used in practicing the present invention.

As used herein, the term carbonaceous material refers to a conductive material essentially consisting of elemental carbon. The term “essentially consisting of”, as used herein, means that minor quantities of other components, such as ash or other impurities, not materially affecting the essential characteristics of the conductive material (i.e. the elemental carbon) can be present. Non-limiting examples of carbonaceous material are, without being limited to, synthetic graphite, natural graphite, amorphous carbon, hard carbon, soft carbon, acetylene black, mesocarbon microbeads, carbon black, Ketjen black, mesoporous carbon, porous carbon matrix, carbon nanotube, carbon nanofiber, carbon nanorods, vapor grown carbon fiber, and graphene. Particularly, the carbonaceous material consists of elemental carbon.

As used herein, mole percentages (mol %) relates to the elemental component to which it is related to. For instance, mol % of an elemental chalcogenide relates to mol % of S, Se, and/or Te, and mol % of carbon relates to mol % of C.

As used herein, “inverse vulcanization process” refers to the copolymerization of a large excess of a chalcogenide with a modest amount of a crosslinking monomer having at least one, particularly two or more, unsaturated double or triple bonds in order to obtain a chalcogenide copolymer, such as a sulfur or a sulfur-selenium copolymer.

As used herein, “a crosslinking moiety” is a moiety linking several chalcogenide chains and results from the reaction of a crosslinking monomer having at least one, particularly two or more, unsaturated double or triple bonds with the ends of a diradical polychalcogenide chain, such as a polysulfide chain. By reaction between the ends of the diradical polychalcogenide chains with the unsaturated sites (double or triple bonds) of the crosslinking monomer covalent bonds are formed. Thus, the crosslinking monomer can link two or more diradical chalcogenide chains and thereby allow for the formation of a network polymer system.

As used herein, a “styrenic monomer” is a monomer that has at least one vinyl functional group, particularly two or more vinyl functional groups. The chalcogenide diradicals can link to the vinylic moieties of the styrenic momomers to form the chalcogenide-styrenic polymer.

As used herein, an “alkynylly unsaturated monomer” is a monomer that has at least one alkynylly unsaturated functional group (i.e. a triple bond), particularly two or more alkynylly unsaturated functional groups. The alkynylly unsaturated monomer can be an aromatic alkyne, both an internal and a terminal alkyne, and a multifunctional alkyne.

An “ethylenically unsaturated monomer” is a monomer that contains at least one ethylenically unsaturated functional group (i.e. double bond), particularly two or more ethylenically unsaturated functional groups.

As used herein, a “polyfunctional monomer” is a monomer that contains at least two ethylenically unsaturated functional groups (i.e. double bond) or alkynylly unsaturated functional groups (i.e. triple bond), or mixtures thereof.

As used herein, the term “embedded” refers to an arrangement of the chalcogenide polymer-carbon composite wherein the carbon component is homogeneously distributed among the chains of chalcogenide polymer or the chalcogenide polymer network.

The term “C-rate” as used herein, refers to a measure of the rate at which a battery is discharged relative to its maximum capacity. A 1 C rate means that the discharge current will discharge the entire battery in 1 hour.

As used herein, the indefinite articles “a” and “an” are synonymous with “at least one” or “one or more.” Unless indicated otherwise, definite articles used herein, such as “the,” also include the plural of the noun.

As mentioned above, a first aspect relates to a chalcogenide polymer-carbon composite comprising: from 70.0 to 99.0 mol % of an elemental chalcogenide, such as sulfur, selenium, telurium, or a mixture thereof; from 0.5 to 20.0 mol % of carbon in the form of a carbonaceous material; and from 0.5 to 10.0 mol % of a crosslinking moiety, with respect to the total amount of chalcogenide, carbon, and crosslinking moiety, wherein the chalcogenide is in the form of chalcogenide chains bonded to the crosslinking moiety and they are forming a structure wherein the carbonaceous material is embedded.

In a particular embodiment, in the chalcogenide polymer-carbon composite the chalcogenide is in an amount of from 82.5 to 94.9 mol %, the carbon is in an amount of from 2.8 to 13.7 mol %, and the crosslinking moiety is in an amount of from 2.3 to 3.8 mol %. More particularly, in the chalcogenide polymer-carbon composite the chalcogenide is in an amount of from 84.3 to 94.9 mol %, the carbon is in an amount of from 2.8 to 13.2 mol %, and the crosslinking moiety is in an amount of from 2.3 to 2.5 mol %. Even more particularly, in the chalcogenide polymer-carbon composite the chalcogenide is in an amount of from 84.5 to 94.6 mol %, the carbon is in an amount of from 2.8 to 13.2 mol %, and the crosslinking moiety is in an amount of from 2.3 to 2.6 mol %.

In a particular embodiment, optionally in combination with one or more features of the particular embodiments defined above, the chalcogenide is sulfur.

In another particular embodiment, optionally in combination with one or more features of the particular embodiments defined above, the chalcogenide is a mixture of sulfur and selenium, and the sulfur is in the form of sulfur chains bonded to the crosslinking moiety and the selenium is intercalated in the sulfur chains in the form of one selenium atom or two selenium atoms bonded to each other. Particularly, the S/Se molar ratio is from 99/1 to 89/11, more particularly of 97.5/2.5, 95.0/5.0, or 92.7/7.5.

In another particular embodiment of the chalcogenide polymer-carbon composite, optionally in combination with one or more features of the particular embodiments defined above, the carbonaceous material is selected from the group consisting of carbon black, graphite particle, natural graphite, artificial graphite, acetylene black, Ketjen black, carbon nanotube, carbon nano fiber, carbon nanorod, and graphene.

In another particular embodiment, optionally in combination with one or more features of the particular embodiments defined above, in the sulfur polymer-carbon composite the crosslinking moiety results from the reaction of a crosslinking monomer selected from the group consisting of a styrenic monomer, an alkynylly unsaturated monomer, an ethylenically unsaturated monomer, and a polyfunctional monomer, and mixtures thereof.

Non-limiting examples of styrenic monomers include, without being limited to, bromostyrene, chlorostyrene, fluorostyrene, (trifluoromethyl)styrene, vinylaniline, acetoxystyrene, methoxystyrene, ethoxystyrene, methylstyrene, nitrostyrene, vinylbenzoic acid, vinylanisole, and vinylbenzyl chloride. In a particular embodiment the crosslinking monomer is a styrenic monomer.

Non-limiting examples of alkynylly unsaturated monomers include, without being limited to, ethynylbenzene, 1-phenylpropyne, 1,2-diphenylethyne, 1,4-diethynylbenzene, 1,4-bis(phenylethynyl)benzene, and 1,4-diphenylbute-1,3-diyne. In a particular embodiment the crosslinking monomer is an alkynylly unsaturated monomer.

Non-limiting examples of ethylenically unsaturated monomers include, without being limited to, vinyl monomers, acryl monomers, (meth)acryl monomers, unsaturated hydrocarbon monomers, and ethylenically-terminated oligomers. In a particular embodiment the crosslinking monomer is an ethylenically unsaturated monomer. Particular examples of such monomers include, mono- or polyvinylbenzenes, mono- or polyisopropenylbenzenes, mono- or polyvinyl(hetero)aromatic compounds, mono- or polyisopropenyl(hetero)-aromatic compounds, acrylates, methacrylates, alkylene di(meth)acrylates, bisphenol A di(meth)acrylates, benzyl (meth)acrylates, phenyl(meth)acrylates, heteroaryl (meth)acrylates, terpenes (e.g., squalene, myrcene), and carotene. Non-limiting examples of ethylenically unsaturated monomers that are non-homopolymerizing include allylic monomers (e.g., diallyl disulfide), isopropenyls, maleimides, norbornenes, vinyl ethers, and methacrylonitrile. The ethylenically unsaturated monomers may include also a (hetero)aromatic moiety such as, for example a phenyl, pyridine, triazine, pyrene, naphthalene, or polycyclic (hetero)aromatic ring system, bearing one or more vinylic, acrylic or methacrylic substituents. Examples of such monomers include benzyl (meth)acrylates, phenyl (meth)acrylates, divinylbenzenes (e.g., 1,3-divinylbenzene, 1,4-divinylbenzene), isopropenylbenzene, styrenics (e.g., styrene, 4-methylstyrene, 4-chlorostyrene, 2,6-dichlorostyrene, 4-vinylbenzyl chloride), diisopropenylbenzenes (e.g., 1,3-diisopropenylbenzene), vinylpyridines (e.g., 2-vinylpyridine, 4-vinylpyridine), 2,4,6-tris((4-vinylbenzyl)thio)-1,3,5-triazine and divinylpyridines (e.g., 2,5-divinylpyridine).

Non-limiting examples of polyfunctional monomers include, without being limited to, polyvinyl monomers (e.g., divinyl, trivinyl), polyisopropenyl monomers (e.g., diisoprenyl, triisoprenyl), polyacryl monomers (e.g., diacryl, triacryl), polymethacryl monomers (e.g., dimethacryl, trimethacryl), polyunsaturated hydrocarbon monomers (e.g., diunsaturated, triunsaturated), polyalkynyl monomers, polydiene monomers, polybutadiene monomers, polyisoprene monomers, polynorbornene monomers and polyalkynylly unsaturated monomers. In a particular embodiment the crosslinking monomer is a polyfunctional monomer.

As disclosed above, chalcogenide polymer-carbon composites, such as sulfur polymer-carbon composites, can be obtained via an “inverse vulcanization” process, the process comprising: a) melting from 70.0 to 99.0 mol % of chalcogenide and adding to the melted chalcogenide from 0.5 to 20.0 mol % of carbon under stirring, or alternatively, melting a mixture of the mentioned amounts of chalcogenide and carbon, in order to form a homogeneous suspension; b) adding to the suspension of step a) from 0.5 to 10.0 mol % of a crosslinking monomer having at least one, particularly two or more, unsaturated double or triple bonds to obtain a reaction mixture; and c) allowing the reaction mixture of step b) to react in order to obtain the chalcogenide polymer-carbon composite.

Mole percentages of crosslinking monomer used in the preparation of the sulfur polymer-carbon composite as defined herein above and below correspond to the mole percentage of crosslinking moiety in the final copolymer.

As an instance, when the chalcogenide is sulfur, by this process, the cyclic allotropes of sulfur (S8) suffer a homolytic cleavage of S—S bonds creating polysulfide bi-radicals. These active species can react with other sulfur species creating macro bi-radicals. When an organic comonomer (e.g. a crosslinking monomer) is added, it reacts with the polysulfide bi-radicals creating a macromolecular structure. Without being bonded by theory, it is believed that the final product contains long polysulfide chains bonded to the organic comonomer molecules forming a structure wherein carbon is embedded.

Similarly, as a way of example, by jointly melting elemental sulfur and selenium, selenium is intercalated in the polysulfide chains and linear selenium-containing polysulfides with diradical chain ends are formed. These active sulfur-selenium species can react among them creating macro diradicals that will react with the crosslinking monomer. Without being bonded by theory, it is believed that the final product contains long polysulfide chains wherein selenium is homogenously intercalated in the polysulfide chains. Particularly, either a selenium atom or two selenium atoms bonded to each other are surrounded by sulfur atoms forming structures of the kind ⋅ ⋅ ⋅ —S—S—Se—S—S— ⋅ ⋅ ⋅ or ⋅ ⋅ ⋅ —S—S—Se—Se—S—S— ⋅ ⋅ ⋅, the selenium atoms being dispersed in the sulfur chains.

As mentioned above, the homogeneous suspension of carbon in melted chalcogenide such as sulfur can be obtained either by:
melting the corresponding amount of chalcogenide and then adding the corresponding amount of carbon under stirring, or
first mixing the corresponding amounts of chalcogenide and carbon and then submitting the mixture to a thermal treatment in order to melt the chalcogenide and form the homogeneous suspension.

As a way of example, melting of sulfur, either alone or in admixture with carbon, can be carried out at a temperature from 120 to 230° C., particularly of 185° C.

In a particular embodiment of the process as defined above, the amount of chalcogenide is from 82.5 to 94.9 mol %, the amount of carbon is from 2.8 to 13.7 mol %, and the amount of crosslinking monomer is from 2.3 to 3.8 mol %. More particularly, the amount of chalcogenide is from 84.3 to 94.9 mol %, the amount of carbon is from 2.8 to 13.2 mol %, and the amount of crosslinking monomer is from 2.3 to 2.5 mol %. Even more particularly, the amount of chalcogenide is from 84.5 to 94.6 mol %, the amount of carbon is from 2.8 to 13.2 mol %, and the amount of crosslinking monomer is from 2.3 to 2.6 mol %.

The crosslinking monomer used in step b) is as defined herein above with relation to the chalcogenide polymer-carbon composite. Particularly, the crosslinking monomer has two or more, unsaturated double or triple bonds.

In certain embodiments, the polymerization reaction can be performed at elevated pressure (e.g., in an autoclave). Elevated pressures can be used to polymerize more volatile crosslinking monomers, so that they do not vaporize under the elevated temperature reaction conditions.”

A chalcogenide polymer-carbon composite obtainable by the process mentioned above also forms part of the invention.

The chalcogenide polymer-carbon composite as defined above can be used to manufacture a positive electrode, i.e. a cathode.

A cathode can be manufactured by casting a slurry containing the chalcogenide polymer-carbon composite as defined above onto a metallic current collector.

The slurry can be prepared by first milling the chalcogenide polymer-carbon composite in order to obtain a fine powder and mixing it with a conductive additive such as a carbonaceous material, also in the form or a fine powder, and mixing the mixture with a binder and a suitable solvent. The binder, most commonly polyvinylidene fluoride (PVDF), is pre-dissolved in the solvent, most commonly N-methyl-2-pyrrolidone (NMP). After uniformly mixing, the resulting slurry is cast onto the current collector and then dried.

Alternatively, the chalcogenide polymer-carbon composite and the conductive additive can be mixed with a thermoplastic polymer, and the mixture can be melted, casted onto the current collector and left cool down.

Examples of carbonaceous material used both for the preparation of the chalcogenide polymer-carbon composite and as a conductive additive in the preparation of the cathode include, without being limited to, synthetic graphite, natural graphite, amorphous carbon, hard carbon, soft carbon, acetylene black, mesocarbon microbeads, carbon black, Ketjen black, mesoporous carbon, porous carbon matrix, carbon nanotube, carbon nanofiber, carbon nanorods, vapor grown carbon fiber, and graphene.

Examples of binder include, without being limited to, polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), gelatine, or mixtures thereof.

Also forms part of the invention a cathode comprising the chalcogenide polymer-carbon composite obtainable by the process mentioned above.

The chalcogenide-carbon battery also comprises an electrolyte. Such electrolytes include a salt and a solvent.

As a way of example, electrolytes for Li-sulfur/carbon batteries may contain lithium salts and organic solvents. Some of the most widely used solvents are ethers such as poly(ethylene glycol), 1,3-dioxolane (DOL), 1,2-dimethoxyethane (DME) or tetra(ethylene glycol) dimethyl ether (TEGDME). Examples of the lithium salts are LiCF₃SO₃ and LiTFSI, among others. In yet other embodiments, the electrolyte comprises a lithium salt and an ionic liquid, such as the lithium salt LiTFSI together with the IL (N-methyl-N-propylpyrrolidone)TFSI.

The cathode as defined above can be used in the manufacture of a chalcogenide-carbon battery. Thus, also forms part of the invention a chalcogenide-carbon battery comprising an anode comprising an element selected from lithium, magnesium, sodium, and calcium; a cathode comprising the chalcogenide polymer-carbon composite obtainable by the process mentioned above, and an electrolyte interposed between the cathode and the anode.

Particularly, in the chalcogenide-carbon battery as defined above the anode comprises lithium which can be in the form of metallic lithium (including lithium alloys), a lithium derivative compound (such as a prelithiated carbon material or an inorganic Li compound), or a combination thereof. More particularly, the anode comprises metallic lithium. The anode can further comprise an inorganic material or an organic material, such as carbon.

Throughout the description and claims the word “comprise” and variations of the word, are not intended to exclude other technical features, additives, components, or steps.

Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim, and shall not be construed as limiting the scope of the claim. Furthermore, the present invention covers all possible combinations of particular and preferred embodiments described herein.

### EXAMPLES

### Example 1—Sulfur Based Cathodic Compositions

Carbon materials used for the synthesis of the sulfur composite or sulfur polymer-carbon composites were Ketjen Black 600JD (KB, from Akzonobel); Graphistrength C100 carbon nanotube (CNT, from Arkema), and Carbon Black C45 (C45, from Timcal).

Table 1 below shows the mole and weight percentages of the different components in a sulfur-carbon composite, a sulfur copolymer (i.e. sulfur copolymerized with DVB), or several sulfur polymer-carbon composites.

TABLE 1

| | | Sulfur based cathodic composition | | | | Sulfur based cathodic composition | | | |
|---|---|---|---|---|---|---|---|---|---|
| | | (% in moles) | | | | (% in weight) | | | |
| Cathode sample | | | | Carbon in | | | | Carbon in | |
| code | | S | DVB | composite | | S8 | DVB | composite | |
| 1 | Sulfur | 60.0 | | KB | 40.0 | 80 | | KB | 20 |
| | composite | | | | | | | | |
| 2 | Sulfur | 97.3 | 2.7 | | | 90 | 10 | | |
| 3 | polymer | 97.3 | 2.7 | | | 90 | 10 | | |
| 4 | Sulfur | 94.6 | 2.6 | KB | 2.8 | 89.1 | 9.9 | KB | 1 |
| 5 | polymer- | 91.9 | 2.5 | KB | 5.6 | 88.2 | 9.8 | KB | 2 |
| 6 | carbon | 91.9 | 2.5 | C45 | 5.6 | 88.2 | 9.8 | C45 | 2 |
| 7 | composite | 88.1 | 2.4 | C45 | 9.5 | 86.9 | 9.65 | C45 | 3.5 |
| 8 | | 91.9 | 2.5 | CNT | 5.6 | 88.2 | 9.8 | CNT | 2 |
| 9 | | 88.1 | 2.4 | CNT | 9.5 | 86.9 | 9.65 | CNT | 3.5 |
| 10 | | 84.5 | 2.3 | CNT | 13.2 | 85.5 | 9.5 | CNT | 5 |

### Comparative Example 1—Preparation of Sulfur/Carbon Composite [1]

The sulfur/carbon composite [1], was prepared adding sulfur and KB in a molar ratio (60:40) and mixing well by ball-milling. The ball-milling was performed in a planetary ball mill (PM200 Retsch) under ambient conditions at a speed of 300 rpm for 3 h. In order to infiltrate the sulfur in the porous carbon structure, the mixture obtained by ball milling was introduced in the oven under argon atmosphere at 150° C. during 6 h. Finally, the mixture was heat treated at 300° C. during 3 h to eliminate the sulfur that was not infiltrated in the carbon porous structure.

The preparation of the positive electrode of the sulfur polymer, was carried out as is described on the example 4, using a 70% of sulfur composite, presenting a final content of 56% of sulfur.

### Comparative Example 2—Preparation of Sulfur Polymer [2]

In a 50 ml round bottom flask equipped with a magnetic stir bar certain amount of elemental sulfur was added. Then the flask was placed in an oil bath preheated at 185° C. After 5 minutes of heating, the sufur was molten. Once a homogeneous solution was obtained, divinylbenzene (DVB) was added. The solution was vigorously stirred until the vitrification of the media. The reaction was allowed to react 5 additional minutes in order to have full conversion of the reactants. Afterwards, the flask was placed into a liquid nitrogen bath in order to quench the reaction and break the black solid in order to get a fine powder. The final sulfur polymer had a final molar ratio composition of S:DVB of 97.3:2.7.

The preparation of the positive electrode of the sulfur polymer was carried out as is described on the example 4, using a 62% of sulfur polymer, presenting a final content of 56% of sulfur.

### Comparative Example 3—Preparation of a Sulfur Polymer [3]

In a 50 ml round bottom flask equipped with a magnetic stir bar certain amount of elemental sulfur was added. Then the flask was placed in an oil bath preheated at 185° C. After 5 minutes of heating, the sufur was molten. Once a homogeneous solution was obtained, divinylbenzene (DVB) was added. The solution was vigorously stirred until the vitrification of the media. The reaction was allowed to react 5 additional minutes in order to have full conversion of the reactants. Afterwards, the flask was placed into a liquid nitrogen bath in order to quench the reaction and break the black solid in order to get a fine powder. The final sulfur polymer had a final molar ratio composition of S:DVB of 97.3:2.7.

The preparation of the positive electrode of the sulfur polymer was carried out as is described on the example 4, using a 72% of sulfur polymer, presenting a final content of 65% of sulfur.

### Example 2—Preparation of Sulfur Polymer-Carbon Composite [4]

In a 50 ml round bottom flask equipped with a magnetic stir bar certain amount of elemental sulfur was added. Then the flask was placed in an oil bath preheated at 185° C. After 5 minutes of heating, the sulfur was molten. Then KB carbon was added under stirring. Once a homogeneous mixture was obtained, divinylbenzene (DVB) was added. The solution was vigorously stirred until the vitrification of the media. The reaction was allowed to react 5 additional minutes in order to have full conversion of the reactants. Afterwards, the flask was placed into a liquid nitrogen bath in order to quench the reaction and break the black solid, in order to get a fine powder. The final sulfur polymer composite had a final molar ratio composition of S:KB:DVB of 94.6:2.8:2.6.

The preparation of the positive electrode with the sulfur-carbon polymer composite [4] was carried out as is described on the Example 4, using a 72% of sulfur polymer, presenting a final content of 64% of sulfur.

Sulfur polymer-carbon composites [5] to [10] were prepared following the same process with the component percentages and the type of carbon as shown in Table 1, and the corresponding positive electrodes were prepared as described in Example 4, using the amounts of sulfur polymer-carbon composite as shown in Table 3.

### Example 3—Preparation of Sulfur-Selenium Polymer-Carbon Composite [4Bis]

In a 50 ml round bottom flask equipped with a magnetic stir bar certain amount of elemental sulfur and selenium were added. Then the flask was placed in an oil bath preheated at 185° C. After 5 minutes of heating, the mixture was molten. Then KB carbon was added under stirring. Once a homogeneous mixture was obtained, divinylbenzene (DVB) was added. The solution was vigorously stirred until the vitrification of the media. The reaction was allowed to react 5 additional minutes in order to have full conversion of the reactants. Afterwards, the flask was placed into a liquid nitrogen bath in order to quench the reaction and break the black solid, in order to get a fine powder. The final sulfur-selenium polymer composite had a final molar ratio composition of S:Se:KB:DVB of 89.9:4.7:2.8:2.6, as shown in Table 2.

TABLE 2

| | | Sulfur/Selenium based cathodic composition | | | | |
|---|---|---|---|---|---|---|
| | | (% in moles) | | | | |
| Cathode sample | | | | | Carbon in | |
| code | | S | Se | DVB | composite | |
| 4Bis | S/Se | 89.9 | 4.7 | 2.6 | KB | 2.8 |
| | polymer- | | | | | |
| | carbon | | | | | |
| | composite | | | | | |

The preparation of the positive electrode of the sulfur-selenium polymer composite, was carried out as is described on the example 4, using a 72% of sulfur-selenium polymer, presenting a final content of 57.5% of sulfur and 7.5% of selenium.

### Example 4—Preparation of Positive Electrodes

Positive electrodes were elaborated using 62-72 wt % of a sulfur-carbon composite ([1] of Comparative Example 1), a sulfur polymer ([2] and [3] of Comparative Examples 2 and 3), a sulfur polymer composite ([4] to [10] of Example 2), or a sulfur-selenium polymer composite [4Bis] of Example 3.

The selected sulfur or sulfur-selenium materials were dried prior to the cathode slurry preparation.

The positive electrodes obtained with the sulfur polymer of comparative Examples 2 [2] and 3 [3] were prepared following the process disclosed in WO2017011533, where a sulfur copolymer is obtained by heating sulfur until it is melt, adding one or more comonomers, and carrying out a polymerization reaction. Thus, only once the sulfur copolymer was obtained the carbon conductive additive was dispersed therein.

For the sake of comparison, previously to the preparation of the cathode slurry, the sulfur composite ([1]), the sulfur polymer ([2] or [3]), the sulfur polymer-carbon composite ([4] to [10]), or the sulfur-selenium polymer-carbon composite ([4Bis]) were mixed by ball milling with an amount of conductive additive (carbon) until a final sulfur content of 80% wt. The ball milling was performed in a planetary ball mill (PM200 Retsch) and at a speed of 300 rpm for 3 hours. Then, the mixtures were subsequently mixed with the binder and the rest of conductive additive to obtain the cathode slurry.

The final cathode formulations contained 62-72 wt % of the selected sulfur or sulfur-selenium material, 18-28 wt % of a conductive additive (C45), and 10% of a binder (PVDF), with a loading of 2 mg_{sulfur} cm⁻². Table 3 shows the compositions of all the cathodes.

The components of final electrode composition were dried and added to a solution of PVDF (Solef® 5130, Solvay) in NMP to form the cathodic slurry. Final slurries having a solid content of 25-30% were prepared by mechanical mixing (RW 20 digital, IKA) at an agitation rate of 600 rpm. These slurries were blade cast onto a carbon coated aluminum foil (MTI Corp.) and dried at 60° C. under dynamic vacuum for 12 h before cell assembling.

Table 3 shows the composition of the different sulfur based cathodic materials and the positive electrodes (cathodes) prepared with them.

TABLE 3

| | | | | | | Cathode composition | | | |
|---|---|---|---|---|---|---|---|---|---|
| | | Sulfur based cathodic composition | | | | (% in weight) | | | |
| | | (% in weight) | | | | S8/Sulfur | | | Sulfur |
| Cathode sample | | | | Carbon in | | polymer- | Conductive | | content |
| code | | S | DVB | composite | | composite | additive | Binder | (wt %) |
| 1 | Sulfur | 80 | | KB | 20 | 70 | 20 | 10 | 56 |
| | composite | | | | | | | | |
| 2 | Sulfur | 90 | 10 | | | 62 | 28 | 10 | 56 |
| 3 | polymer | 90 | 10 | | | 72 | 18 | 10 | 65 |
| 4 | Sulfur | 89.1 | 9.9 | KB | 1 | 72 | 18 | 10 | 64 |
| 5 | polymer- | 88.2 | 9.8 | KB | 2 | 72 | 18 | 10 | 64 |
| 6 | carbon | 88.2 | 9.8 | C45 | 2 | 72 | 18 | 10 | 64 |
| 7 | composite | 86.9 | 9.65 | C45 | 3.5 | 72 | 18 | 10 | 63 |
| 8 | | 88.2 | 9.8 | CNT | 2 | 72 | 18 | 10 | 64 |
| 9 | | 86.9 | 9.65 | CNT | 3.5 | 72 | 18 | 10 | 63 |
| 10 | | 85.5 | 9.5 | CNT | 5 | 72 | 18 | 10 | 62 |

Sulfur-selenium based cathodic material and the corresponding positive electrodes was prepared similarly as cathode sample [4].

### Example 5.—Preparation of Coin Cells

Coin half cells (2025, Hohsen) were prepared with the cathodes 1 to 10, and 4Bis obtained in Example 4. Lithium metal (0.05 mm, Rockwood Lithium) was used as the anode. One layer of commercial polyolefin separator (Celgard 3501) soaked with 50 μL of a 0.38 M solution of bis(trifluoromethane)sulfonimide lithium salt (LiTFSI) (Sigma-Aldrich) and 0.32 M solution of lithium nitrate (LiNO3) (Sigma-Aldrich) as additive, in 1/1 (v/v) mixture of dimethoxyethane (DME) (BASF) and dioxolane (DOL) (BASF), was placed between the electrodes. Vacuum drying of electrodes and cell crimping was performed in a dry room with dew point below −50° C. Thereafter, assembled cells were aged during 20 hours and then cycled by BaSyTec Cell Test System (Germany) at 25±1° C. by air conditioning.

The electrochemical behavior of the obtained cathodes was evaluated at different C-rates taking into account the theoretical capacity of elemental sulfur (1672 mAh/g). The cycle life of coin cells was investigated within 1.7-2.6 V intervals at C/5 charge and discharge current rates.

The capacity of the coin cell having sulfur based cathodic materials [1] to [10] at different current intensity applied during the charge/discharge cycle and at different cycle number was measured.

The performance of cathodes based on elemental sulfur-carbon composite (sample code [1]) was compared with cathodes based on sulfur polymer and either a high or a low conductive additive content ([2] and [3]), and with cathodes based on different sulfur polymer-carbon composites according to the invention ([4] to [10]).

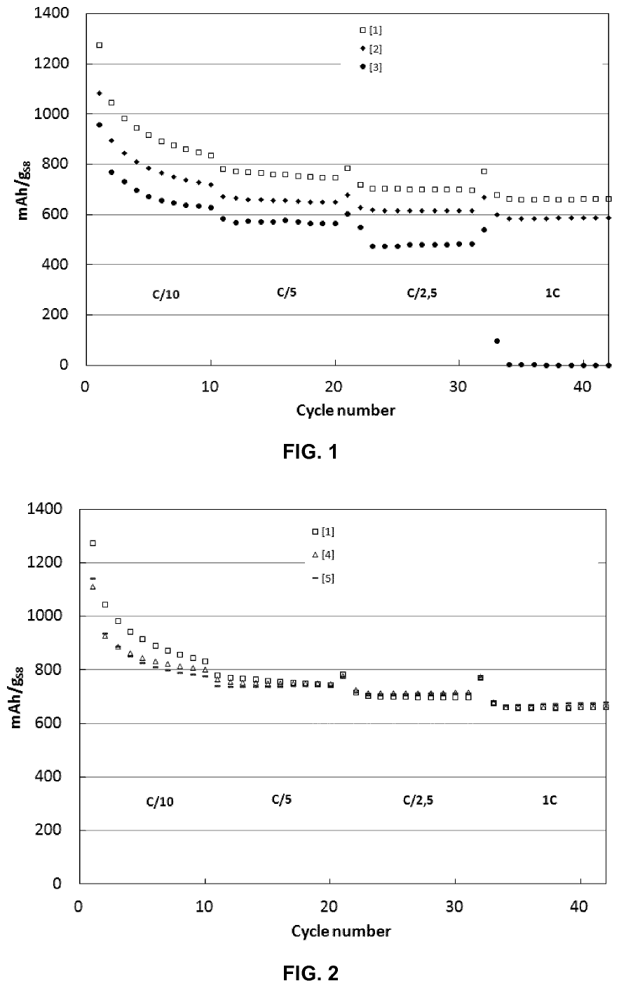

As it can be seen, by comparing the cathode formulations with the lowest sulfur contents (i.e. samples [1] and [2]), the behavior of the conventional cathode based on elemental sulfur-carbon composite [1] shows a trend similar to the one based on sulfur polymer [2] at the different current intensities studied, but the specific capacity of the sulfur polymer based electrode is lower, even at low current intensities. In addition, the increase of the sulfur polymer content in the cathode [3] has a negative effect on its electrochemical performance (lower capacity) (see FIG. 1)

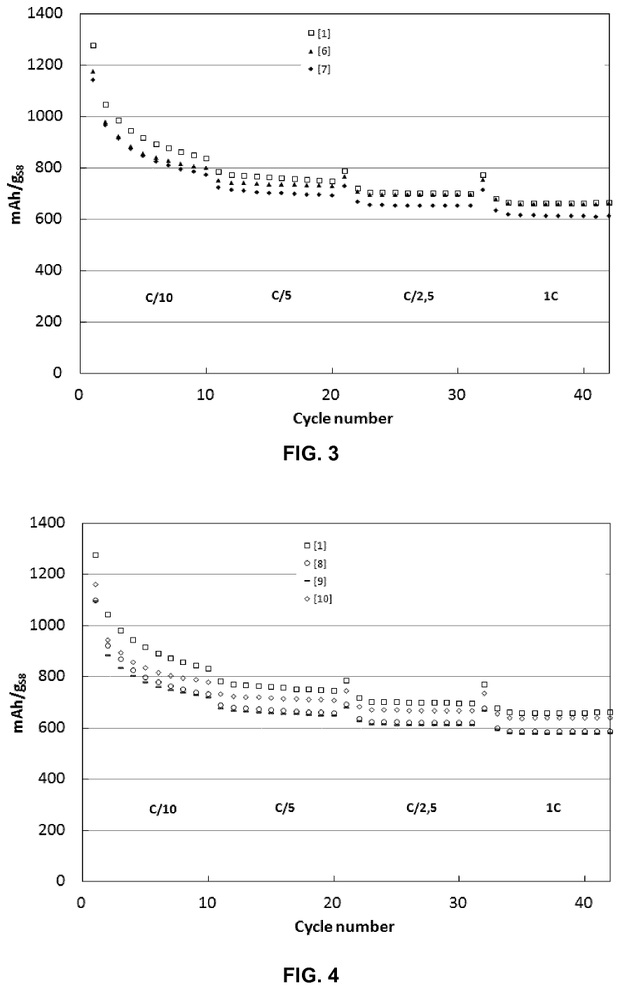

Cathodes based on the sulfur polymer-carbon composites of the invention ([4] to [10]) show a behavior similar to the reference based on elemental sulfur-carbon composite [1], even though the sulfur content in the former ones is higher (64 wt %). That is, the negative effect observed in the sulfur polymer based systems ([2] and [3]) when the sulfur content is increased (FIG. 1), does not take place in the sulfur polymer-carbon composite based systems of the invention (FIGS. 2 to 4).

Thus, as it was explained above, the addition of a certain amount of carbon during the sulfur inverse polymerization not only improves the electrochemical performance of the system but also makes it possible to increase the final content of sulfur in the electrode and thus, the energy density of the battery.

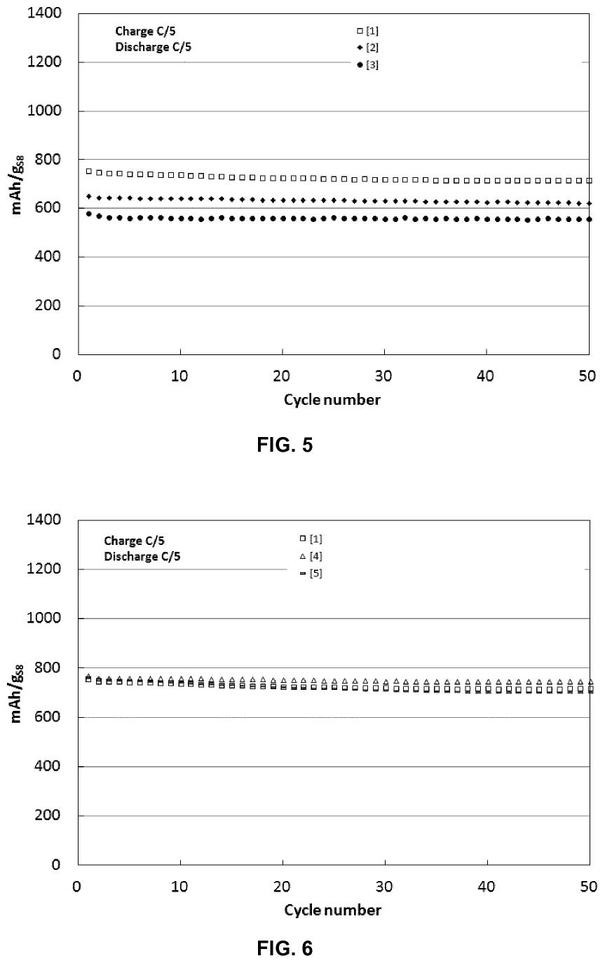

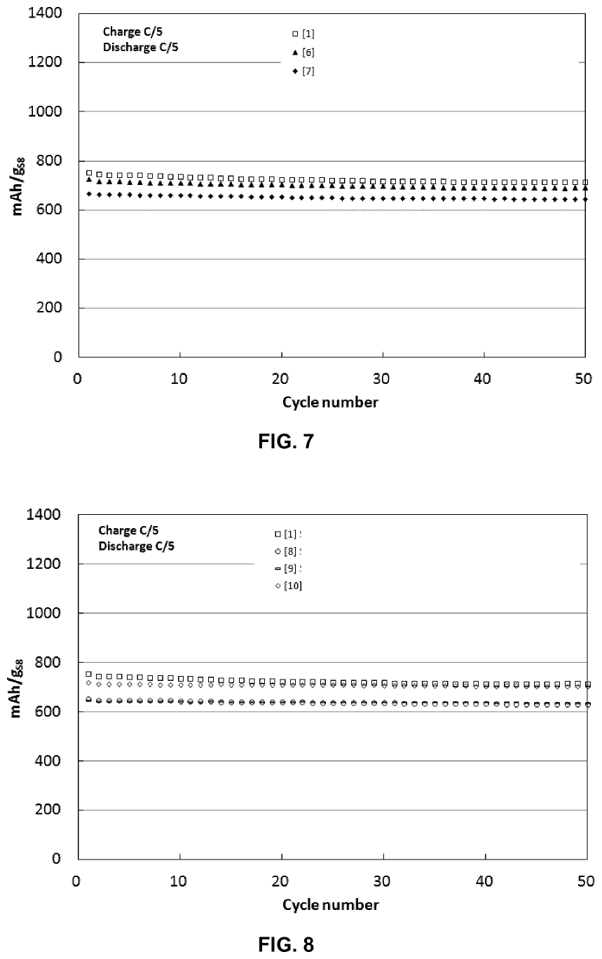

Focusing on the results of the capacity per gram of sulfur during the cycling of the battery at a current intensity equivalent to 5 hours of charge/discharge, as shown in FIG. 5, batteries prepared with sulfur polymer show lower specific capacities [2, 3], especially at higher sulfur contents [3], than the reference system based on elemental sulfur-carbon composite [1]. However, the specific capacity is recovered when the batteries use the sulfur polymer-carbon composites [4] and [5] instead of the sulfur polymers, as it is shown in FIG. 6. Similar results are obtained when other types of carbon were used to prepare the sulfur polymer-carbon composites [6] to [10] (FIGS. 7 and 8), or when a sulfur-selenium polymer [4Bis] is used (FIG. 9).

### Example 6.—Preparation of Sulfur Polymer-Carbon Composites Using Different Crosslinkers (CL)

In a 50 ml round bottom flask equipped with a magnetic stir bar, certain amount of elemental sulfur was added. Then the flask was placed in an oil bath preheated at 185° C. After 5 minutes of heating, the sulfur was molten. Then KB carbon was added under stirring. Once a homogeneous mixture was obtained, different crosslinker agents were evaluated separately [1,3-diisopropenyl benzene (DIB), divinylbenzene (DVB), diallyl disulfide (DAS) and myrcene (Myr)]. Once the crosslinker was added, the solution was vigorously stirred until the vitrification of the media. The reaction was allowed to react 5 additional minutes in order to have full conversion of the reactants. Afterwards, the flask was placed into a liquid nitrogen bath in order to quench the reaction and break the black solid, in order to get a fine powder. The final sulfur polymer composites had a final molar ratio composition of S:KB:CL of 94.6:2.8:2.6. The sulfur polymer-carbon composite powder was further mixed by ball milling with conductive additive until a final sulfur content of 80% wt. The ball milling was performed in a planetary ball mill (PM200 Retsch) and at a speed of 300 rpm for 3 hours.

The preparation of the positive electrode of the sulfur polymer composite was carried out as described on Example 4, presenting a final content of 64% of sulfur.

Coin cells were prepared as in Example 5. The cycle life of coin cells was investigated within 1.7-2.6 V intervals at C/5 charge and discharge current rates.

Results obtained with DVB correspond to the sulfur polymer composite [4] of Example 2. As shown in FIG. 10, similar results are obtained with DAS and Myr, and even a better performance is observed with DIB.

### CITATION LIST

1. Wang et al. (“Sulfur-carbon nano-composite as cathode for rechargeable lithium battery based on gel electrolyte”, Electrochem. Commun. 2002, Vol. 4, pp. 499-502.
2. Griebel et al. “Kilogram Scale Inverse Vulcanization of Elemental Sulfur to Prepare High Capacity Polymer Electrodes for Li—S Batteries”; J. Polymer Sci., Part A: Polym. Chem., 2015, Vol. 53, pp. 173-177.
3. WO2017011533

1. A chalcogenide polymer-carbon composite comprising:
from 70.0 to 99.0 mol % of a chalcogenide;
from 0.5 to 20.0 mol % of carbon in the form of a carbonaceous material, and
from 0.5 to 10.0 mol % of a crosslinking moiety,
with respect to the total amount of chalcogenide, carbon, and crosslinking moiety,
wherein the chalcogenide is in the form of chalcogenide chains bonded to the crosslinking moiety, characterized in that the chalcogenide chains bonded to the crosslinking moiety are forming a structure wherein the carbonaceous material is embedded.

2. The chalcogenide polymer-carbon composite according to claim 1, wherein the chalcogenide is sulfur.

3. The chalcogenide polymer-carbon composite according to claim 1, wherein the chalcogenide is a mixture of sulfur and selenium.

4. The chalcogenide polymer-carbon composite according to claim 3, wherein the sulfur/selenium molar ratio is from 99/1 to 89/11.

5. The chalcogenide polymer-carbon composite according to claim 1, wherein the carbonaceous material is selected from the group consisting of carbon black, graphite particle, natural graphite, artificial graphite, acetylene black, Ketjen black, carbon nanotube, carbon nano fiber, carbon nanorod, and graphene.

6. The chalcogenide polymer-carbon composite according to claim 1, wherein the crosslinking moiety results from the reaction of a crosslinking monomer selected from the group consisting of a styrenic monomer, an alkynylly unsaturated monomer, an ethylenically unsaturated monomer, and a polyfunctional monomer, and mixtures thereof.

7. A process for the preparation of a chalcogenide polymer-carbon composite as defined in claim 1 by inverse vulcanization, the process comprising:
a) melting from 70.0 to 99.0 mol % of the chalcogenide and adding to the melted chalcogenide from 0.5 to 20.0 mol % of carbon in the form of a carbonaceous material under stirring, or
alternatively, melting a mixture of the mentioned amounts of chalcogenide and carbon,
in order to form a homogeneous suspension;
b) adding to the suspension of step a) from 0.5 to 10.0 mol % of a crosslinking monomer having at least one unsaturated double or triple bonds to obtain a reaction mixture; and
c) allowing the reaction mixture of step b) to react in order to obtain the chalcogenide polymer-carbon composite.

8. The process according according to claim 7, wherein the crosslinking monomer is selected from the group consisting of an styrenic monomer, an alkynylly unsaturated monomer, an ethylenically unsaturated monomer, and a polyfunctional monomer, and mixtures thereof.

9. The process according according to claim 8, wherein the crosslinking monomer is an styrenic monomer selected from the group consisting of bromostyrene, chlorostyrene, fluorostyrene, (trifluoromethyl)styrene, vinylaniline, acetoxystyrene, methoxystyrene, ethoxystyrene, methylstyrene, nitrostyrene, vinylbenzoic acid, vinylanisole, and vinylbenzyl chloride.

10. The process according according to claim 8, wherein the crosslinking monomer is an alkynylly unsaturated monomer selected from the group consisting of ethynylbenzene, 1-phenylpropyne, 1,2-diphenylethyne, 1,4-diethynylbenzene, 1,4-bis(phenylethynyl)benzene, and 1,4-diphenylbuta-1,3-diyne.

11. The process according according to claim 8, wherein the crosslinking monomer is an ethylenically unsaturated monomer selected from the group consisting of a vinyl monomer, an acryl monomer, a (meth)acryl monomer, an unsaturated hydrocarbon monomer, and an ethylenically-terminated oligomer.

12. The process according according to claim 8, wherein the crosslinking monomer is a polyfunctional monomer selected from the group consisting of a polyvinyl monomer, a polyisopropenyl monomer, a polyacryl monomer, a polymethacryl monomer, a polyunsaturated hydrocarbon monomer, a polyalkynyl monomer, a polydiene monomer, a polybutadiene monomer, a polyisoprene monomer, a polynorbornene monomer, and a polyalkynylly unsaturated monomer.

13. A cathode comprising the chalcogenide polymer-carbon composite as defined in claim 1.

14. A chalcogenide/carbon battery comprising:
a) an anode comprising an element selected from the group consisting of lithium, magnesium, sodium, and calcium;
b) a cathode comprising the chalcogenide polymer-carbon composite as defined in claim 1; and
c) an electrolyte interposed between the cathode and the anode.

15. The chalcogenide/carbon battery according to claim 14, wherein the anode comprises lithium.

16. The chalcogenide polymer-carbon composite according to claim 3, wherein the crosslinking moiety results from the reaction of a crosslinking monomer selected from the group consisting of a styrenic monomer, an alkynylly unsaturated monomer, an ethylenically unsaturated monomer, and a polyfunctional monomer, and mixtures thereof.

17. The process according to claim 7, wherein the chalcogenide is sulfur or a mixture of sulfur and selenium.

18. The process according to claim 7, wherein the sulfur/selenium molar ratio is from 99/1 to 89/11.

19. The cathode according to claim 13, wherein the chalcogenide is sulfur or a mixture of sulfur and selenium.

20. The chalcogenide/carbon battery according to claim 14, wherein the chalcogenide is sulfur or a mixture of sulfur and selenium.
